(19) United States
(12) Patent Application Publication
(10) Pub. No.: US 2024/0165741 A1
(43) Pub. Date: May 23, 2024

(54) METHODS FOR WELDING COMPONENTS OF BATTERY MODULES

(71) Applicant: JAGUAR LAND ROVER LIMITED, Whitley, Coventry, Warwickshire (GB)

(72) Inventors: Paul HANEY, Coventry, Warwickshire (GB); Oliver BAILEY, Coventry, Warwickshire (GB)

(21) Appl. No.: 18/551,812

(22) PCT Filed: Mar. 31, 2022
(86) PCT No.: PCT/EP2022/058706

§ 371 Date: Sep. 21, 2023

(30) Foreign Application Priority Data
Mar. 31, 2021 (GB) 2104576.0

(51) Int. Cl. B23K 26/21; B60L 50/64; H01M 50/213; H01M 50/505; H01M 50/516

(52) U.S. Cl. CPC B23K 26/21; B60L 50/64; H01M 50/213; H01M 50/505; H01M 50/516; H01M 2220/20

(57) ABSTRACT

Embodiments of the present disclosure provide components for batteries, and methods of manufacture of batteries or battery modules. In some embodiments, the methods comprise producing a plurality of sub-assemblies comprising a group of mechanically-connected cells and an associated busbar assembly, and subsequently assembling the sub-assemblies within a housing and electrically connecting the busbar assemblies to produce a battery module.

### TECHNICAL FIELD

The present invention relates generally to methods for welding components of battery modules. In particular, but not exclusively, the invention relates to methods of welding busbars of vehicle battery modules to the terminals of cells, especially to the terminals of cylindrical cells. Aspects of the invention relate to a method of laser welding a tab associated with a busbar to an electrical cell, to a battery module, to a busbar component, and to a vehicle.

### BACKGROUND

There has recently been increased interest in providing battery-powered vehicles, which has led to developments in vehicle battery, in particular vehicle traction battery technology. In the manufacture of vehicle traction batteries, it is often necessary to weld a large number of cells to one or more busbar assemblies. It is generally desirable to perform such welds as quickly and reliably as possible. Furthermore, certain designs of battery module require welds to be located on relatively small areas on the cells, which can make reliable welding more difficult.

It is an object of embodiments of the invention to at least mitigate one or more of the problems of the prior art.

### SUMMARY OF THE INVENTION

According to an aspect of the invention for which protection is sought, there is provided a method of laser welding a tab associated with a busbar to a terminal of an electrical cell, the method comprising: positioning the tab in contact with the terminal; welding the tab to the terminal by controlling a laser welding system to produce a weld on a portion of the tab that contacts the terminal, wherein the weld has a weld shape comprising a substantially straight portion; and measuring a depth of the weld in the straight portion during the step of welding the tab to the terminal. Advantageously, the straight portion may provide a convenient location for the measurement, and may enable a measurement system to take accurate and repeatable measurements of the depth of the weld. In particular, a measurement system such as a Inline Coherent Imaging (ICI) may be operable to measure the depth of the weld along a stable, straight portion of the weld. Advantageously, the weld depth may be measured in real time, so that it may be possible to make adjustments to the welding parameters during an individual weld. Alternatively, the depth measurement may be used to determine whether or not a weld depth was within predetermined limits, and the weld may be reworked or the part rejected if the weld depth was outside the predetermined limits.

In an embodiment, welding the tab comprises controlling the laser to produce a weld comprising oscillations about a centreline of the weld shape. The oscillations may comprise a first component in a direction parallel to the weld path and a second component in a direction normal to the weld path. For example, the oscillations may be circular oscillations. Advantageously, oscillating about the weld path may help to spread the weld energy over a larger area, and produces a stronger weld.

In an embodiment, the frequency of the oscillations is between 300 and 700 Hz, preferably between 500 and 650 Hz. The oscillations may have an amplitude of less than 0.5 mm. For example, the amplitude may be between 0.01 mm and 0.5 mm, or between 0.1 mm and 0.5 mm. Oscillations of this amplitude and frequency, when coupled with other factors such as the focus and power of the welding laser beam, provide an optimum balance of heat input to form the weld and yet also prevent penetration of the weld into the interior of the cell.

In an embodiment, the electrical cell is a cylindrical cell comprising a first end surface, wherein a first terminal of the cell is located in a central region of the first end surface and at least part of a second terminal of the cell is located in a peripheral region of the first end surface, and the step of welding the tab to the terminal comprises welding the tab to the peripheral region of the first end surface. Such cylindrical cells are widely available and have been shown to be useful in automotive battery modules.

In an embodiment, the method is a method of welding the tab to at least first and second cylindrical cells, wherein the tab is positioned in contact with the peripheral regions of both of the first and second cells and subsequently welded to the peripheral regions of each of the first and second cells. The first and second cells circumferentially abut one another. By “circumferentially abut” it is meant that at least a portion of the cylindrical surface of the first cell abuts the cylindrical surface of the second cell. A layer of a suitable adhesive may be provided between the abutting first and second cells to connect the cells together.

In an embodiment, the straight portion has a length of at least 1.5 mm, preferably around 2 mm. This may provide a suitable length to ensure stabilisation of the measurement, and also helps to provide a strong weld.

The depth of the weld may be measured by inline coherent imaging (ICI). ICI provides a convenient method for measuring the depth of a laser weld, and the present inventors have recognised that measuring using ICI on a straight portion of a weld during measurement provides an accurate and non-destructive method of measuring the weld depth in real time.

In an embodiment the weld shape comprises a stabilisation portion prior to the substantially straight portion to allow the welding to stabilise prior to the substantially straight portion. The stabilisation portion may be another portion of the weld that is straight or nearly straight, but in which measurement is not performed because the weld depth may not yet have stabilised after the transition between the curved and straight portions. For example, the stabilisation portion may have a length of at least 0.1 mm, preferably around 0.2 mm. This may provide a suitable length to ensure stabilisation of the measurement.

In an embodiment, the weld shape comprises a plurality of substantially straight portions. In some embodiments, measurement may be provided in a plurality of substantially straight portions in each weld. Alternatively, the measurement may only be performed in only one of the substantially straight portions per weld.

In an embodiment, the weld shape comprises a continuous loop. Optionally, the continuous loop comprises a disco-rectangle. A disco-rectangle shape may also be referred to as a “stadium” or “racetrack” shape.

The method may further comprise: prior to welding the tab to the terminal, scanning the tab positioned in contact with the terminal of the electrical cell to determine a position of the tab; and repositioning at least one of: the tab; and the focus of the laser, such that the distance between the tab and the focus of laser is equal to a predetermined distance. Advantageously, scanning the tab and repositioning the tab and/or the focal position allows the laser to provide the desired spot size on the tab. It will be understood that the cell is moved with the tab if the tab is repositioned, to maintain contact between the cell and the tab.

In an embodiment, the predetermined distance may be between zero and 1 mm, preferably 0.5 mm.

According to a further aspect of the invention for which protection is sought, there is provided a battery module comprising a plurality of electrical cells and a busbar component, wherein: each of the electrical cells comprises a terminal; the busbar component comprises a plurality of tabs; and each of the tabs are welded to the respective terminals of one or more of the electrical cells by a weld that has a weld shape that includes a substantially straight portion.

In an embodiment the electrical cells are cylindrical cells each having a first end surface, wherein a first terminal of each cell is located in a central region of the first end surface and at least part of a second terminal of each cell is located in a peripheral region of the first end surface, wherein a plurality of the busbar tabs are each welded to the peripheral region of the first end surface of one or more of the cells.

In an embodiment each of the cylindrical cells circumferentially abuts at least one other cylindrical cell.

According to a further aspect of the invention for which protection is sought, there is provided a control system comprising one or more controllers, the control system configured to control a laser welding system to produce weld connecting a tab to a terminal of an electrical cell, wherein the weld has a weld shape comprising a substantially straight portion, the control system being further configured to control an inline coherent imaging system to measure a depth of the weld in the substantially straight portion.

According to a further aspect of the invention for which protection is sought, there is provided a battery pack comprising a plurality of battery modules as described above.

According to a further aspect of the invention for which protection is sought, there is provided a vehicle comprising a battery module, a battery pack, or a control system as described above.

According to another aspect of the invention for which protection is sought, there is provided a busbar component comprising an aluminium body and a conductive sheet electrically connected to the aluminium body, wherein the sheet comprises a plurality of tabs arranged to protrude from the aluminium body, each tab being connectable to a terminal of an electrical cell, wherein the conductive sheet comprises copper plated with a metallic layer, wherein the metallic layer comprises nickel or titanium. Advantageously, such a component is relatively light and low-cost. The metallic layer facilitates making of laser welded connections between copper and aluminium, and may also facilitate laser welding of the tabs to other metallic components, such as cell terminals. For example, the metallic layer may reduce reflectivity at infrared wavelengths, which may be particularly important in the event that the connections between the aluminium body and the conductive sheet are made by an infrared laser welding system.

The metallic layer may also help to reduce oxidation of the outer surfaces of the conductive sheet, which improves weld quality and reduces the overall electrical resistance of the busbar component.

In an embodiment, the conductive sheet is welded to the aluminium body. The conductive sheet may be laser welded to the aluminium body, for example using an infrared laser welding system.

In an embodiment, at least part of the aluminium body extends in a first plane and the plurality of tabs are arranged to depend from the aluminium body at least partly in a direction normal to the first plane. Advantageously, the tabs depending in a direction normal to the first plane allows the tabs to be welded to cell terminals, without the rest of the busbar component coming into contact with the cell terminals.

In an embodiment, the conductive sheet has a thickness of 0.2-0.4 mm preferably 0.3 mm.

In an embodiment, wherein the metallic layer has a thickness of 0.5-5 microns.

According to a further aspect of the invention for which protection is sought, there is provided a method of manufacture of a busbar component comprising: providing an aluminium body and a conductive sheet, wherein the conductive sheet comprises copper plated with nickel or titanium; positioning the conductive sheet in contact with the aluminium body; and welding the conductive sheet to the aluminium body using a laser welding system.

According to another aspect of the invention for which protection is sought, there is provided a method of laser welding a tab associated with a busbar to a terminal of an electrical cell, wherein the electrical cell is a cylindrical cell comprising a first end surface, wherein a first terminal of the electrical cell is located in a central region of the first end surface and at least part of a second terminal of the electrical cell is located in a peripheral region of the first end surface, the method comprising: positioning the tab in contact with the peripheral region of the first end surface; welding the tab to the second terminal of the electrical cell by controlling a laser to produce a weld on a portion of the tab that contacts the peripheral region. Advantageously, this allows a single-sided busbar assembly to be laser welded to one or more cells. This may allow the connections between the busbar and the cells to be made very quickly, thereby reducing manufacturing time.

The method may further comprise: prior to welding the tab to the second terminal, scanning the first end surface of the cell to determine a position of the first end surface; and

repositioning the cell and/or the focus of laser such that the distance between the first end surface and the focus of the laser is equal to a predetermined distance. The predetermined distance may be between 0 and 1 mm.

In an embodiment, the method is a method of welding the busbar component to at least first and second cylindrical cells, wherein the tab is positioned in contact with the peripheral region of both of the first and second cells and subsequently welded to the peripheral regions of each of the first and second cells. Advantageously, this may reduce the number of tabs required to connect to a given number of cells.

In an embodiment, the first and second cells circumferentially abut one another.

In an embodiment, welding the tab comprises controlling the laser to follow a weld shape comprising oscillations about a centreline of a weld shape. This may help to spread the energy from the laser over a larger area.

Optionally, the oscillations are circular oscillations.

In an embodiment, the frequency of the oscillations is between 300 and 700 Hz, preferably between 500 and 650 Hz.

In an embodiment, wherein the oscillations have an amplitude of less than 0.5 mm. For example, the oscillations may have an amplitude of 0.01-0.5 mm, or 0.1-0.5 mm. Preferably, the oscillations have an amplitude of around 0.3 mm.

According to another aspect of the invention for which protection is sought, there is provided a battery module comprising a plurality of cells and a busbar component, wherein: each of the cells is a cylindrical cell comprising a first end surface, wherein a first terminal of the cell is located in a central region of the first end surface and at least part of a second terminal of the cell is located in a peripheral region of the first end surface, the busbar component comprises a plurality of tabs; and a plurality of the busbar tabs are each welded to the peripheral regions of one or more of the cells.

Optionally, a plurality of the busbar tabs are each welded to the peripheral region of the first end surface of two of the cells.

Optionally, each of the cylindrical cells circumferentially abuts at least one other cylindrical cell. For example, each of the cylindrical cells may circumferentially abut two or more other cylindrical cells.

According to another aspect of the invention for which protection is sought, there is provided a battery pack comprising a plurality of battery modules as described above.

According to another aspect of the invention for which protection is sought, there is provided a vehicle comprising a battery module or a battery pack as described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIGS. 1A-C show different views of a cylindrical cell that may be used in a vehicle battery module (PRIOR ART);

FIG. 2 shows a laser welding system (PRIOR ART);

FIG. 3 shows an exploded view of a sub-assembly for use in a battery module;

FIG. 4A shows an exploded view of a battery module in another embodiment of the present invention;

FIG. 4B shows an enlarged view of the connections between the tabs of the busbar assembly and the electrical cells in the battery module shown in FIG. 4A;

FIG. 5 shows the shape of the welds for electrically connecting the tabs of a busbar assembly to two adjacent electrical cells in an embodiment of the invention;

FIG. 6 shows the shape of the welds for electrically connecting the tabs of a busbar assembly to two adjacent electrical cells in another embodiment of the invention;

FIGS. 7A and 7B show the shape of the welds for electrically connecting the tabs of a positive and negative busbar assemblies to two adjacent electrical cells in another embodiment of the invention;

FIG. 8A shows an exploded view of a busbar assembly in an embodiment of the present invention;

FIG. 8B shows an assembled version of the busbar assembly shown in FIG. 8A;

FIG. 9 shows a flow chart illustrating a method of welding a busbar assembly to one or more cylindrical cells in an embodiment of the present invention;

FIG. 10 shows a flow chart illustrating a method of welding a busbar assembly to one or more cylindrical cells in another embodiment of the present invention;

FIG. 11 shows a method of manufacture of a busbar component according to an embodiment of the present invention;

FIG. 12 shows a laser welding system comprising a measuring device; and

FIG. 13 shows a vehicle in an embodiment of the present invention.

### DETAILED DESCRIPTION

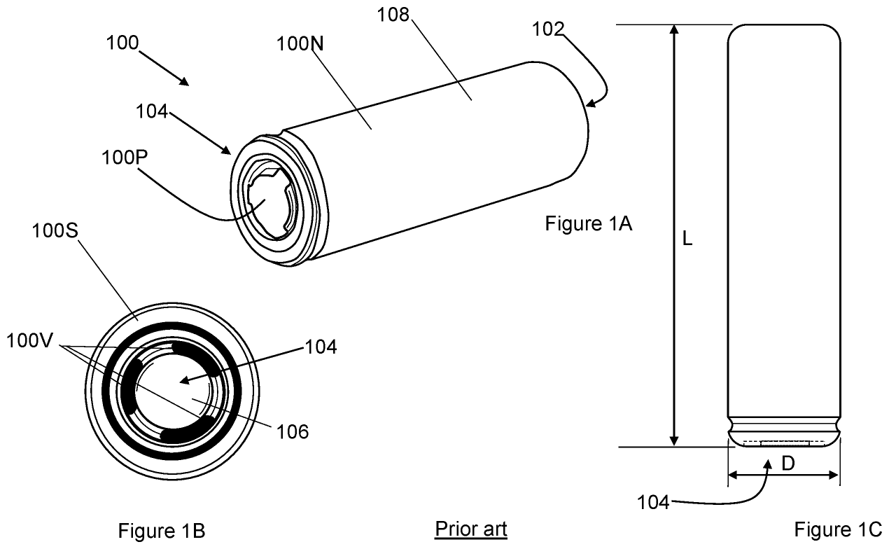

FIGS. 1A-C show different views of a conventional cylindrical cell 100. Cylindrical cells 100 are widely available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used in embodiments of the present invention.

As will be well understood by the skilled person, the cell 100 comprises a positive terminal 100P, a negative terminal 100N, and vent means 100V. The positive terminal is provided by a steel or aluminium end cap 106 in a central region of the first end 104 of the cell, and the negative terminal is provided by a steel cylindrical case 108. The steel cylindrical case 108 covers the second end 102, the entire cylindrical surface between the first and second ends, and a peripheral region 100S of the first end surface. The peripheral region of the first end surface may also be referred to as a “shoulder” region 100S of the first end surface 104. In commercially-available cells, it is sometimes the case that the end cap that defines the positive terminal 100P on the first end surface 104 protrudes beyond the shoulder region of the first end surface, although this is not the case in the cell shown in FIG. 1. This allows a substantially planar connector to be connected to the positive terminal and not the negative terminal. As will be well understood by the skilled person, it is important to avoid direct electrical connections between the positive and negative terminals, as such connections create a short circuit which may damage the cell.

As shown in FIG. 1, the cell 100 comprises three vent means 100V in the first end surface 104, between the end cap 106 that defines the positive terminal 100P and the shoulder region 100S of the steel cylindrical case 108. The vent means 100V are gaps that are covered by a material that will rupture to allow hot gases to escape through the gap between the end cap 106 and steel cylindrical case 108 in the event of excessive pressure occurring inside the cell, thereby mitigate against the risk of the cell exploding.

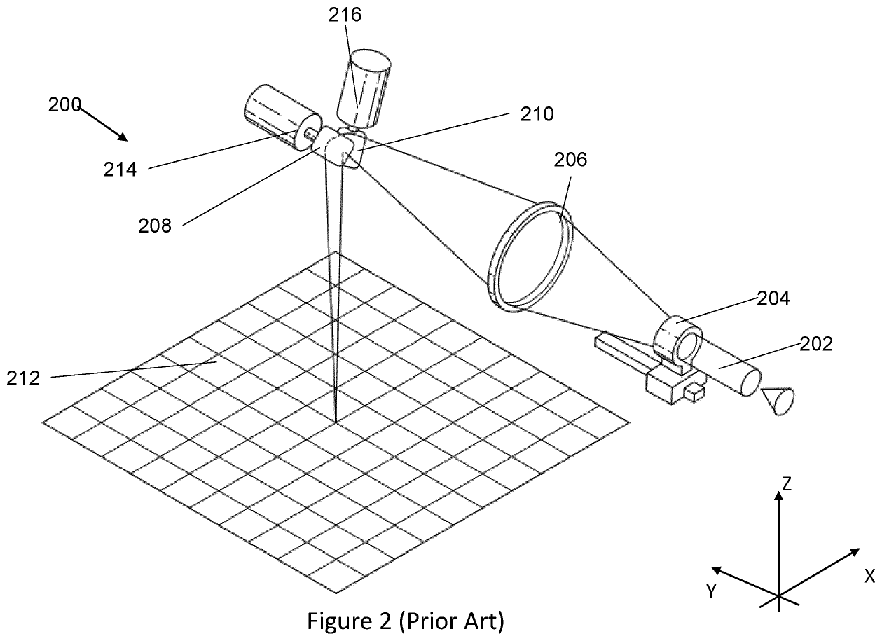

FIG. 2 shows a laser welding system 200. The system 200 comprises a high-powered laser (not shown), which produces a laser beam 202. Beam 202 passes through a diverging lens 204, and a converging lens 206, before being deflected towards a target location in the welding plane 212 by first and second mirrors 208, 210. Each of the mirrors 208, 210 is rotatable about a single axis under the control of a respective galvanometer 214, 216. The axes about which the mirrors 208, 210 are rotated about are mutually perpendicular, so that the first mirror 208 controls the target location of the beam in the X direction and the second mirror 210 controls the target location of the beam in the Y direction.

The lens 204 is movable along an axis parallel to the initial direction of the beam 202, which allows the position of the focal point of the laser, and therefore the welding plane, to be adjusted in the Z direction. It will be understood that the laser may be focused to provide a “spot” in, or close to, the welding plane of a predetermined size. Furthermore, it will be understood that in some laser welding systems the lens 204 may be fixed, so that the focus position of the welding laser is not adjustable in the Z direction. Such systems are referred to as two-dimensional, as they are only operable to direct the beam in the X and Y directions; for such two-dimensional systems, instead of repositioning the focus of the laser (as described below), a distance between a surface of a cell to be welded and the focus of the laser equal to a predetermined distance may be achieved by repositioning the cell. For example, a jig holding the cell(s) during welding may be controllably moveable in the Z-direction in order to permit adjustment of the distance between the surface of a cell to be welded and the focus of the laser.

A controller (not shown) is operable to control the power of the laser and to selectively turn the laser on or off. The controller is also operable to adjust the focal position by moving the lens 204, and to adjust the target position of the laser by controlling the angular positions of the mirrors first and second mirrors 208, 210, via the respective galvanometers 214, 216. Accordingly, an operator may program the controller to make a predetermined set of welds by actuating the laser only when it is directed at selected target regions. As will be well understood by the skilled person, laser welding systems such as the one illustrated in FIG. 2 are able to produce welds very rapidly and with fine control over the weld power and shape. They are therefore particularly useful in situations in which several components in close proximity must be rapidly welded together.

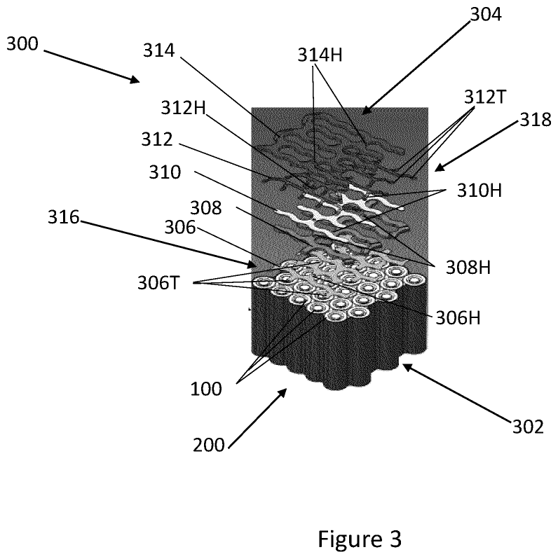

FIG. 3 shows an exploded view of a sub-assembly 300 for incorporation into a battery module including a plurality of tabs 306T, 312T which are to be welded to target locations on the respective cells 100, as will be described in more detail below.

The sub-assembly 300 comprises a group of cells 301, which are mechanically joined together using adhesive prior to connection of the busbar assembly and which have an electrically-insulating wrap 302 disposed around the group of cells, such that the outer-facing cylindrical surfaces of the cells in the group 301 are all covered by the wrap 302. A single-sided busbar assembly 304 is provided adjacent to the first ends of the cells within the group of cells 301. The busbar assembly 304 is arranged to electrically connect all of the cells within the group 301 in parallel with one another. As will be discussed in more detail below, the single-sided busbar 304 assembly is a busbar assembly in which the connections and collection plates for the positive and negative terminals for a given group of cells 301 are located at the same side of the group of cells. It will be understood that in alternative embodiments, separate busbar assemblies may be provided at the first end 104 and the second end 102 of the cells to connect to the positive and negative terminals of a group of cells, respectively.

Busbar assembly 304 comprises a negative collection plate 308 arranged to be electrically connected to the negative terminals of all of the cells within the group of cells 301. The connection between the negative collection plate 308 and the negative terminals of the cells is facilitated by thin metallic sheet 306. In the illustrated embodiment, the negative collection plate 308 is formed from Aluminium and the metallic sheet 306 is formed from Copper plated with Nickel. In the illustrated embodiment, the copper sheet is 0.2-0.3 mm thick, and the thickness of the nickel coating is around 43 micro meters. It will be understood that other thicknesses of copper sheet and nickel coating are also useful, and that other materials are also useful for the sheet and coating.

The electrical and mechanical connections between the negative terminals, the metallic sheet 306 and the negative collection plate 308 will be discussed in more detail below.

Busbar assembly 304 further comprises a positive collection plate 314 arranged to be electrically connected to the positive terminals of all of the cells within the group of cells 301. The connections between the positive collection plate 314 and the positive terminals of the cells is facilitated by a further thin metallic sheet 312. The metallic sheet 312 may be Copper plated with Nickel, wherein the Copper is 0.2-0.4 mm thick, preferably approximately 0.3 mm thick and the Nickel coating is around 1-5 micro meters thick, preferably around 3 micro meters thick. An insulating layer 310 is positioned between the negative collection plate 308 and the thin metallic sheet 312, to ensure that the positive and negative collection plates are electrically isolated from one another.

Before the busbar assembly 304 is connected to the group of cells 301, each of the thin metallic sheets 306, 312 are electrically and mechanically connected to the respective collection plate 308, 314, by welding a portion of the metallic sheet to the respective collection plate. Although this can be achieved by any suitable welding method, laser welding through the thin metallic sheets is particularly effective. The present inventors have recognised that the Nickel coating on the Copper sheet can help to facilitate laser welding of the sheet to both the collection plate and the cell terminals. Although the Copper sheet is coated with Nickel in the present embodiment, in alternative embodiments other coating materials, such as Titanium, may be used.

Once the metallic sheet 306 is welded to the negative collection plate 308, a negative busbar component 316 is formed having a plurality of negative tabs 306T extending away from the body of the negative collection plate 308. As will be explained in more detail below, the negative tabs 306T can be welded to the negative terminals of the cells in the group of cells 301, and the positioning of the tabs is such that each cell 100 can be connected to a respective tab 306T when the negative busbar component 316 is correctly positioned relative to the group of cells 301. Similarly, when the thin metallic sheet 312 is welded to the positive collection plate 314, a positive busbar component 318 is formed. The positive busbar component comprises a plurality of positive tabs 312T that can be welded to respective positive terminals of the cells in the group of cells 301, and the positioning of the tabs is such that each cell 100 can be connected to a respective tab 312T when the positive busbar component 318 is correctly positioned relative to the group of cells 301. As can be seen from FIG. 3, the negative tabs 306T are coplanar with the rest of the metallic sheet 306, whereas the positive tabs 312T extend outwardly and downwardly from the portions of the metallic sheet 312 that are welded to the positive collection plate 314. This allows the positive tabs to pass through void spaces in the negative busbar component 316 and the insulating layer 310 and to connect to the positive terminals of the cells 100, without contacting any part of the negative busbar component. It will be appreciated that the extent to which the tabs 312T extend downwardly will depend, at least in part, on the shape of the cells used in the group, in particular, the extent to which the end cap 106 extends above, or is recessed below, the shoulder region 100S.

Once the positive and negative busbar components 316, 318 are formed by welding the metallic sheets to the respective collection plates, the busbar assembly 304 may be formed by mechanically joining the positive and negative busbar components, with the insulating layer 310 disposed between the two busbar components. This may be achieved by passing electrically-insulating fixings through the aligned holes 314H, 312H, 310H, 308H, 306H in the collection plates, the metallic sheets and the insulating layer. Additionally or alternatively, the insulating layer 310 may have integrally formed fixings arranged to locate into and cooperate with through holes in the busbar components, these fixings may then be heat staked or ultrasonically welded once the busbar components have been correctly placed either side of the insulating layer. Additionally or alternatively, the two busbar components may be secured to the insulating layer 310 by a suitable electrically insulating adhesive or by an overmoulding process

Once the busbar assembly 304 is formed, it is positioned adjacent to the group of cells 301 such that the positive and negative tabs 306T, 312T are in contact with the positive and negative terminals of the cells 100 within the group of cells 301. The tabs are then electrically and mechanically connected to the respective terminals by laser welding, using a system 200 as shown in FIG. 2. The welding process will be described in more detail below.

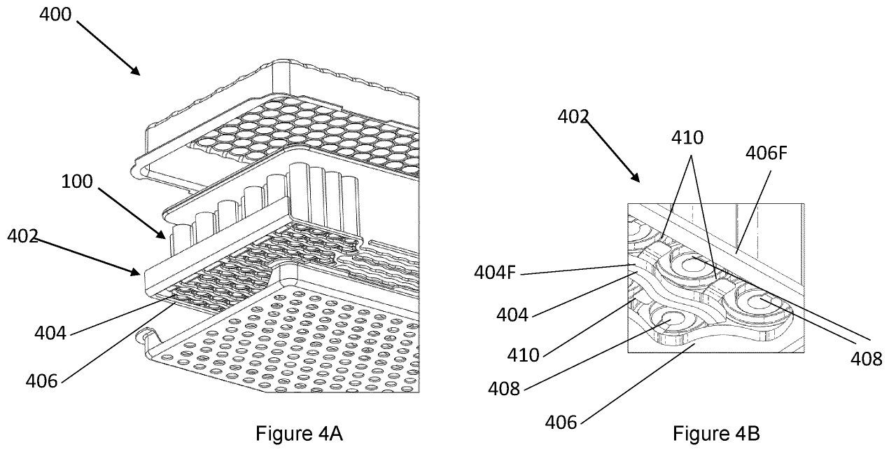

FIGS. 4A and 4B show a battery module 400 in another embodiment of the present invention. The battery module comprises a busbar assembly 402 having a positive collection plate 404 and a negative collection plate 406. In a similar manner to the sub-assembly 300 shown in FIG. 3, connections between the cells 100 and the components of the busbar assembly 402 are made via respective tabs 408, 410. However, the positive and negative collection plates 404, 406 comprise interleaved fingers 404F, 406F, which allow the components to be located in the same plane. Accordingly, it is not necessary for the tabs on one of the collection plates 404, 406 to extend towards the cells in a direction normal to the plane in which the busbar components are located, and both sets of tabs 408, 410 may be provided on substantially planar metallic sheets. In the illustrated embodiment, tabs 408, 410 are provided by sheets of nickel-plated copper, which sheets are laser welded to the respective collection plates prior to assembly of the battery module.

In both the sub-assembly 300 shown in FIG. 3 and the battery module 400 shown in FIG. 4, when the busbar assembly is in its intended position adjacent to the first ends of the cells 100, the positive and negative connection tabs are in contact with the respective terminals of the cells, as best seen in FIG. 4B. Most of the negative connection tabs are in contact with the shoulder regions of two adjacent cells, although some of the negative connection tabs may contact only one cell.

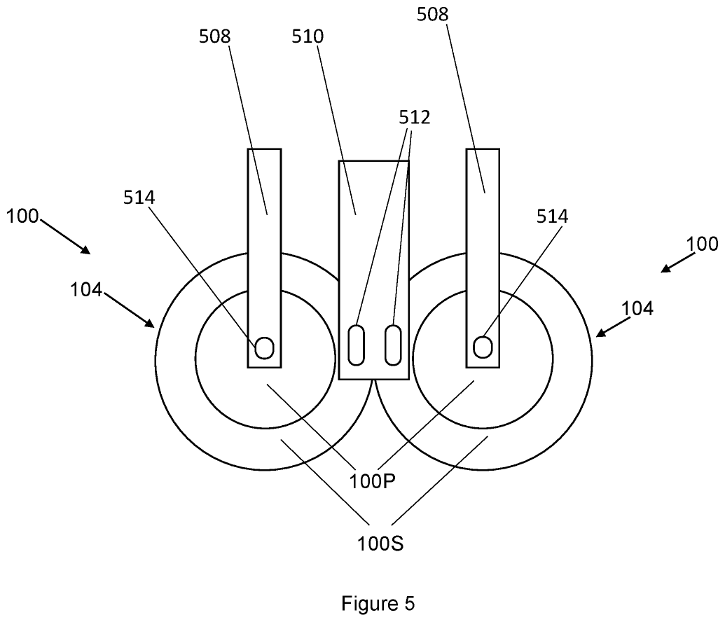

FIG. 5 shows the connections of two positive connection tabs 508 and a negative connection tab 510 to two adjacent cells 100. The negative connection tab 510 is in contact with the shoulder region 100S of each of the two cells 100. Each of the positive connection tabs is in contact with the positive terminal (cell end cap) 100P of a respective one of the cells 100. FIG. 5 also shows the shape of the welds which are used to connect the respective tabs 508, 510 to the cells 100.

Each of the positive tabs 508 is connected to the positive terminal by a weld 514, which is produced by a laser welding system 200 similar to that shown in FIG. 2. As will be well understood by the skilled person, a laser welding system 200 can be programmed to produce a weld having a circular shape as shown in FIG. 5 by controlling the focal point of the laser to follow a weld path having a centreline that substantially corresponds to the shape of the desired weld. However, the present inventors have recognised that it is preferable to distribute the energy over a larger surface area than would be the case if the focal point of the laser was to simply follow the centreline of the weld shape. Accordingly, the focal point is preferably controlled to oscillate about the centreline of the weld shape. Such oscillations may be entirely in a direction perpendicular to the centreline, or they may include a component that is aligned with the centreline. In the illustrated embodiment, the oscillations are circular oscillations. Accordingly, when the weld is produced the controller of the laser welding system 200 controls the focal point of the laser to constantly describe small circles, whilst the centre of the circles follows a path corresponding to the weld shape 514. In the illustrated embodiment, the diameter of the small circles is 0.3 mm, and the diameter of the weld shape 514 is 3 mm. The frequency of the circular oscillations is 600 Hz, the speed of the movement along the centreline of the weld shape is approximately 140 mm/s, and the power of the laser is set to 560 W. The laser weld spot size is set to 30 microns, although any spot size between 20 and 80 microns would be suitable. Preferably, the laser weld spot size is between 30-45 micro meters. At the beginning of the weld, the laser power is increased from zero to full power (560 W) in a linear fashion over a 2 ms “ramp in” period, and at the end of the weld the laser power is decreased from full power to zero, again in a linear fashion, over a 4 ms “ramp out” period. The present inventors have recognised that the above combination of weld parameters produces a strong and reliable weld between the tabs and the positive terminal of the cells, although other combinations of weld parameters are also useful.

It will be understood that, when welding to a cell, it is important to control the depth of the weld accurately, as it is necessary to provide some penetration of the cell casing to provide an adequate weld, but it is undesirable to fully penetrate the outer casing or end cap of the cell, or to heat the “jelly roll” or any of the other temperature-sensitive components within the cell to any significant extent, as this could cause the cell to malfunction in use. Furthermore, control of the weld depth is complicated by the presence of dissimilar materials, because the power needed to melt each of the two materials is different. The present inventors have developed a method of laser welding that ensures a suitable depth of penetration when welding thin tabs 510 to the shoulder regions 100S of one or more cells 100.

As shown in FIG. 5, the negative connection tab 510 is electrically and mechanically connected to the shoulder regions of the two adjacent cells 100 by respective welds 512, which have a “racetrack” shape that is curved at the top and bottom ends, with two straight regions in between the curved ends. This shape may be referred to as a discorectangle or as a stadium. The racetrack shape shown in FIG. 5 is advantageous firstly because it makes efficient use of the available space on the shoulder region 100S, and also because the inclusion of the straight regions provides a convenient location for real-time measurement of the weld depth during welding, using an inline coherent imaging (ICI) measurement system.

As will be understood by the skilled person, ICI employs a separate measurement laser beam in addition to the high-powered laser that is used to make the welds, and can be used to measure the penetration depth of a laser weld. The measurement laser uses the same optics as the high-powered laser, but has a considerably lower power output. Reflections from the measurement laser are detected, and the depth to which the high-powered laser has penetrated can be inferred from these reflections.

It has hitherto proved challenging to implement measurement of laser weld depth using ICI when welding two dissimilar materials together. This difficulty is exacerbated when one of the materials is copper, which is particularly reflective. The problems caused by the reflectivity of copper are at least partially overcome by coating the copper tabs with Nickel, which is less reflective than copper.

However, the present inventors have observed that ICI results can be more accurate when the weld shape follows a substantially straight path.

For each of the welds 512, ICI monitoring of the weld penetration depth by ICI is only performed on the straight regions of the weld. As discussed above, the measurement beam passes through the same optics as the high-powered beam. As such, the measurement beam follows a similar path as the high-powered beam.

In some embodiments, the welding may be performed using constant weld parameters, and the derived weld depths may be used to identify parts in which the weld depth is outside of the specified limits. Such parts may be reworked, or in some cases scrapped. In such embodiments, the weld parameters may be similar to those used in the welding of the tabs 508 to the end caps 100P. However, in alternative embodiments, the derived weld depths may be used in a feedback control system to adjust one or more weld parameters during the welding operation to maintain a weld depth as close as possible to a predetermined target weld depth. Such a feedback control system may control the weld parameters during individual welds, or it may adjust the parameters between welds. Such a control system may reduce the incidence of welds whose depths fall outside the specification limits, and therefore reduce the need to rework or scrap parts.

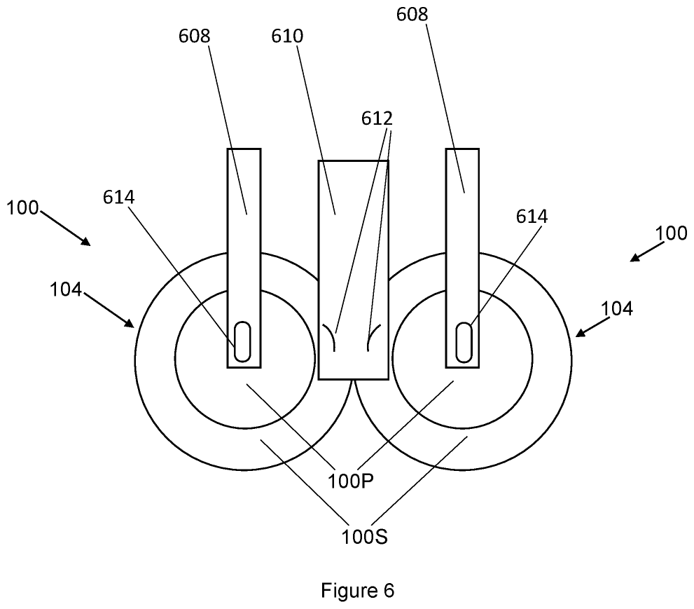

FIG. 6 shows the shapes of the welds between the positive and negative terminals of a cell 100 in an alternative embodiment of the present invention. Similar to the embodiment shown in FIG. 5, the welds to the negative terminal are located in the shoulder region 100S, and the welds to the positive tab 100P are in a central region of the first end. However, in FIG. 6, the welds 614 connecting the positive tabs 608 to the positive terminals are discorectangle shaped and as such have two straight regions in which depth monitoring by ICI can conveniently be performed. Furthermore, the welds 612 connecting the negative tab 610 to the shoulder regions 100S of the cells each have the shape of a single, continuous, curved line.

In some embodiments, depth monitoring may only be performed in the straight portions of the discorectangle shaped welds 614, or may not be performed at all.

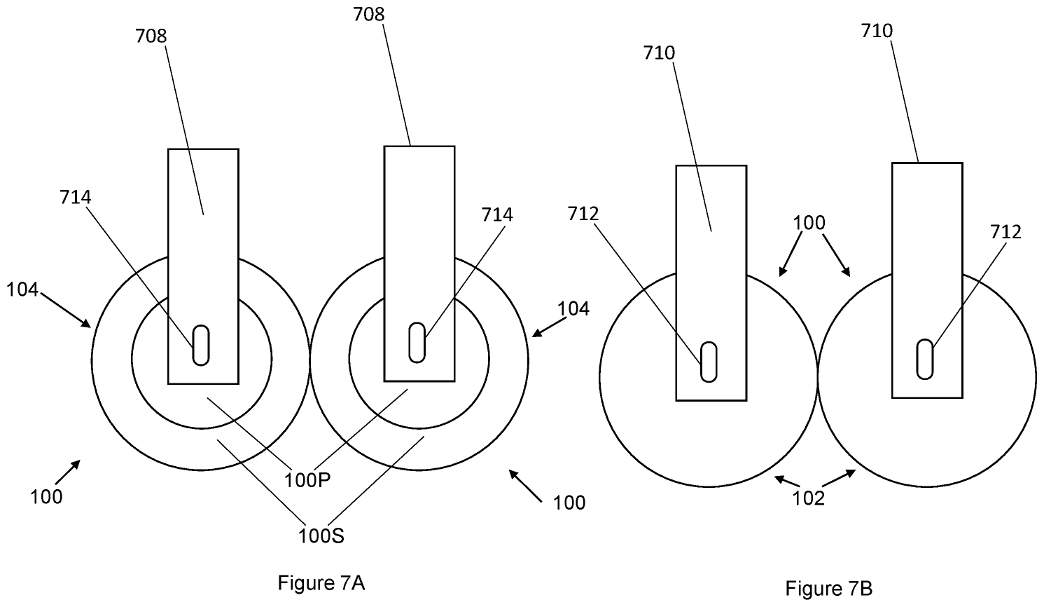

FIGS. 7A and B shows the shapes of the welds between the positive and negative terminals of a cell 100 in an alternative embodiment in which separate busbar assemblies are provided at the first and second ends of the cells. It will be understood that the busbar assembly located at the first end 104 of the group of cells is connected to the positive terminals and the busbar assembly located at the second end 102 is connected to the negative terminals. As shown in FIG. 7A, the positive connection tabs 708 are located at the first end of the cells 104, and are welded to the positive terminals of the cells by discorectangle-shaped welds 714. As discussed above, the discorectangle-shaped welds provide a straight region in which weld depth measurement by ICI can conveniently be performed.

FIG. 7B shows the welds connecting the negative connection tabs to the negative terminal. In the embodiment illustrated in FIGS. 7A and 7B, the negative connection tabs 710 are welded to the cells 100 at the second ends of the cells 102, so that separate positive and negative busbar assemblies may be provided at the first and second ends of the cells, respectively. The welds connecting the negative connection tabs 710 to the second ends of the cells 102 are also discorectangle-shaped 712, and the depth of the weld can be measured in the straight regions of the discorectangles using ICI.

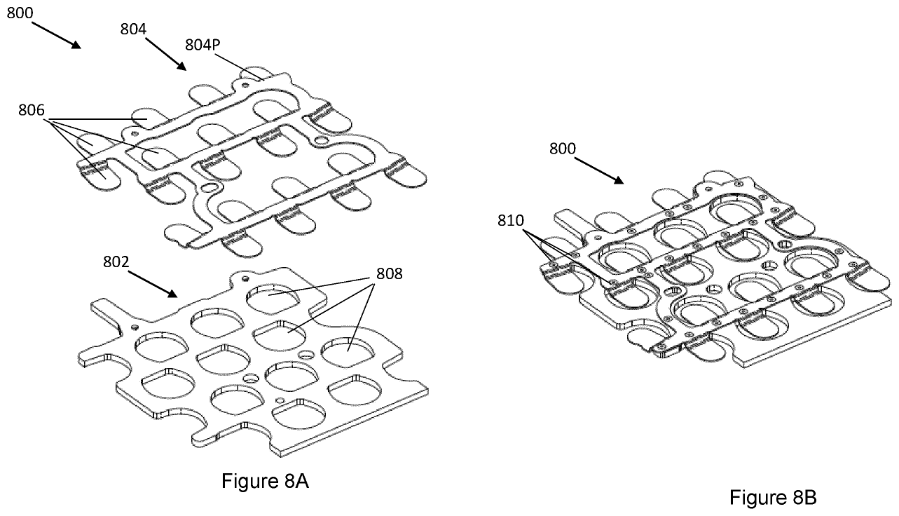

FIG. 8A shows an exploded view of a busbar component 800 comprising an aluminium body 802 and a conductive sheet 804. The conductive sheet comprises copper plated with a metallic layer, which is nickel in the illustrated embodiment. However, in other embodiments different metals may be employed, such as titanium. The conductive sheet 804 comprises a plurality of tab portions 806, each of which is configured to be welded to a terminal of a respective cell. In the illustrated embodiment, the conductive sheet comprises copper having a thickness of approximately 0.3 mm, plated with nickel having a thickness of approximately 3 microns. However, it will be understood that other thicknesses are also useful. For example, the copper sheet may have a thickness of 0.2-0.4 mm, and the metallic layer may have a thickness of 0.5-5 microns.

Advantageously, the metal layer may help to prevent oxidation of the copper in the conductive sheet 804. Furthermore, in some embodiments, the conductive sheet may be connected to the aluminium body 802 and/or the cells by laser welding, and in such embodiments the metallic layer may help to improve absorption of the laser energy at the wavelengths used by a laser welding system.

FIG. 8B shows the busbar component 800 in assembled form, with the locations of the welds 810 indicated. As discussed above, the welds 810 may be produced by a laser welding system.

As can be best seen in FIG. 8B, the aluminium body 802 is substantially planar. However, the conductive sheet 804 has a planar portion 804P which is attached to a face of the aluminium body, and a plurality of tabs 806, which depend from the planar portion 804P and extend in a direction normal to the plane of the aluminium body and the planar portion of the conductive sheet. Several of the tabs 806 protrude through apertures 808 in the aluminium body, and others extend beyond the aluminium body. The tabs 806 allow the busbar component 800 to be electrically connected to the terminals of a plurality of cells 100, without the risk of electrical connections taking place between the cells and any other part of the busbar component 800. This is particularly important when the busbar component is used to make parallel connections between the positive terminals of a plurality of cells 100 as shown in FIGS. 1A-C. When connecting positive terminals in parallel, it is essential to avoid any connections to the negative terminals (for example the shoulder region 100S).

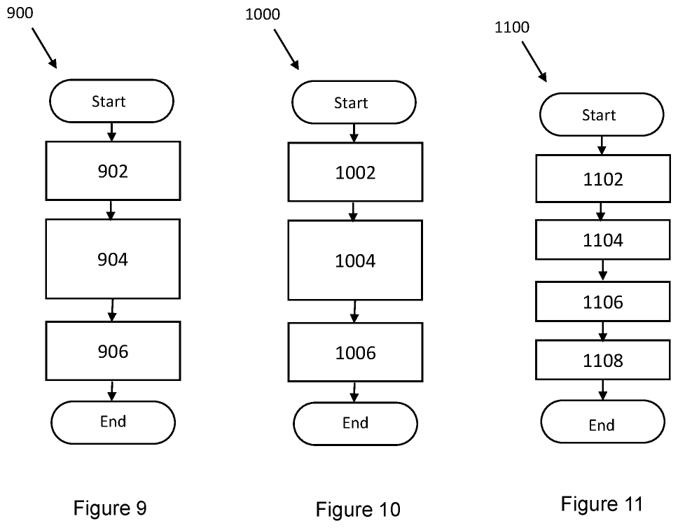

FIG. 9 shows a flow chart of a method 900 for laser welding a tab associated with a busbar to a terminal of an electrical cell in another embodiment of the present invention.

The method begins at step 902, in which the tab is positioned in contact with one of the terminals of the cell. The method then proceeds to step 904, in which a laser welding system is controlled to produce a weld on the portion of the tab that contacts the terminal, the weld having a weld shape including at least one substantially straight portion. The depth of the weld in the substantially straight portion is measured in step 906, which takes place during the welding, after which the method ends. The measurement may be performed by ICI, as discussed above.

FIG. 10 shows a method 1000 for making a busbar component. The method starts with step 1002, in which an aluminium body and a conductive sheet are provided. The conductive sheet comprises copper coated with a metallic layer to prevent oxidation, which may comprise nickel or titanium.

The method then proceeds to step 1004, in which the conductive sheet is positioned in contact with the aluminium body. The method then proceeds to step 1006, in which the conductive sheet is welded to the aluminium body using a laser welding system.

FIG. 11 shows a flow chart of a method 1100 for laser welding a tab associated with a busbar to a terminal of a cylindrical electrical cell according to an embodiment of the present invention.

The method begins in step 1102, in which the tab is positioned in contact with the peripheral, or shoulder, region 100S of a first end surface of the cell 100. As discussed above, the shoulder region 100S is typically part of the negative terminal of the cell 100. The method then proceeds to step 1104, in which the first end surface of the cell is scanned to determine a position of the first end surface. The method then proceeds to step 1106, in which the cell and/or the focus of the laser is repositioned such that a distance between the first end surface and the focus of the laser is equal to a predetermined distance. The method then proceeds to step 1108, in which the laser welding system is controlled to produce a weld on the portion of the tab that is in contact with the peripheral regions 100S. The method then ends.

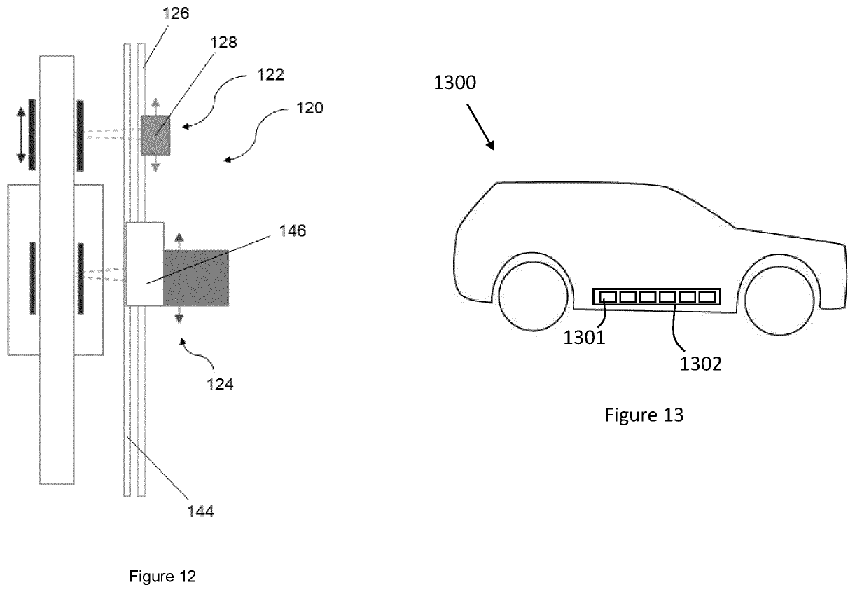

The laser welding process may be performed by a laser welding system shown generally at 120 in FIG. 12. The laser welding system 120 comprises a measuring device comprising a laser rangefinder 122, in addition to a welding laser device 124. The laser rangefinder 122 is used in scan and determine actual connection tab positions with respect to a z-axis direction, and this information is used on a per connection tab/per cell 100 basis to reposition the cell and/or the focus of the laser such that a distance between the first end surface and the focus of the laser is equal to a predetermined distance.

Initially the cell array may be formed by securing the cells 100 relative to each other using adhesive. Alternative methods may however be used. In some embodiments for instance, the cells 100 are secured relative to each other by a carrier into which the cells are placed and wherein cells 100 may be fixed by adhesive. The carrier may provide location features for holding individual cells in position within the array. The cells 100 may be arranged in the cell array so as to form, for example, five columns and twelve rows, to give a total of sixty cells 100 in the cell array. The cells 100 are all oriented in the same manner and are arranged side by side with the top surfaces of the connection tabs substantially aligned to a common surface plane.

The positioning step 1102 puts the cell array and connection tabs 312T, 306T in position for laser welding. The positioning step sets in space, with respect to the first axis (which may be considered the Z-axis), the position of the cell array and the connection tabs 312T, 306T of the busbar. In this embodiment it is assumed that the first axis is a vertical axis. Nonetheless, in other embodiments the first axis may be offset from vertical and could for instance be horizontal. The positioning step also sets the position of the cell array and connection tabs 312T, 306T in space with respect to a second axis and a third axis. The second and third axes are perpendicular to each other and to the first axis. In this embodiment the second and third axes are horizontal. The positioning step is achieved through use of a positioning system comprising a welding jig (into which the cell array and connection tabs 312T, 306T are placed) and the action of a clamping assembly. With the cell array and connection tabs 312T, 306T placed therein, the welding jig is arranged to secure the cell array in an orientation such that the longitudinal axis of the cells 100 is arranged vertically and therefor is aligned with the first axis. Further, such that the top surfaces of the connection tabs 312T, 306T are perpendicular to the first axis. Similarly, the welding jig supports the positive busbar 110 in such a manner that a common surface plane of the connection tabs 312T. 306T is substantially perpendicular to the first axis. The clamping assembly applies a force on the connection tabs 312T, 306T towards their respective positive terminals 100P, bringing them, where they were not already, into contact therewith. In this embodiment the clamping assembly comprises an array of cylindrical bodies, one for each cell 100 in the cell array, having an end surface which is applied to the connection tab 312T. 306T and an open centre through which measuring and welding steps are performed with respect to each connection tab 312T, 306T and corresponding positive terminal 100P.

With the cell array and connection tabs 312T. 306T positioned for laser welding, the scanning step 1104 is performed by the measuring device. The measuring device comprises a rangefinder repositioning assembly and a laser rangefinder 122 comprising a laser rangefinder source (not shown) and a laser rangefinder receiver (not shown). The rangefinder repositioning assembly comprise a rangefinder rail 126 and a rangefinder cart 128 on which the laser rangefinder 122 is mounted. The rangefinder cart 128 comprises running wheels (not shown) which support the rangefinder cart 128 on the rangefinder rail 126 and at least one of which is selectively driven by a motor (not shown) also provided on the rangefinder cart 128, to selectively reposition the rangefinder cart 128 (and so the laser rangefinder 122) along the rangefinder rail 126. The rangefinder rail 126 is aligned with the second axis which corresponds to the direction in which the columns of the cell array run. The rangefinder rail 126 is located with respect to the cell array when mounted in the welding jig such that the laser rangefinder source is positionable so as to be substantially aligned in the first axis direction with each of the cells 100 in a particular column of the cell array, and further such that the positive connection tab 312T. 306T for the relevant cell 100 would be between the positive terminal 100P of that cell 100 and the laser rangefinder source. In the measuring step, the rangefinder cart 128 is progressively moved along the rangefinder rail 126 such that it successively encounters closest points of approach to each of the positive connection tabs 312T, 306T in the relevant column. As it travels, the laser rangefinder source emits a measuring laser beam towards the cell array. When the measuring laser beam is incident on a surface, it is reflected therefrom and received by the laser rangefinder receiver. The time taken between emission of the measuring laser beam from the laser rangefinder source and its detection by the laser rangefinder receiver is indicative of the distance travelled by the measuring laser beam and therefore the position of the surface with respect to the first axis.

At intervals, the measuring laser beam will be reflected from an instance of the cylindrical bodies of the clamping assembly and thereafter from the corresponding connection tabs 312T, 306T and the end surface of the cell 100. A received signal at the rangefinder receiver where the measuring laser beam is reflected from an instance of the cylindrical bodies may be distinctive (e.g. the cylindrical body may define a raised section such that the distance travelled by the measuring laser beam may be characteristically and reliably reduced). Similarly, there may be a characteristic increase in distance travelled as the measuring laser beam is first reflected by an instance of the cylindrical bodies and then by the corresponding positive connection tab 312T, 306T and the end surface of the cell 100 via the open centre of the relevant cylindrical body. In the present embodiment, one or more such features are recognised and used to index the interval at which measurements of the distance travelled by the measuring laser beam are taken to be indicative of the position of the first end surface.

Following the scanning step 1104, the repositioning step 1108 is performed. In this step, the cell and/or the focus of the laser may be repositioned such that a distance between the first end surface and the focus of the laser is equal to a predetermined distance.

For example, the lens 204 (FIG. 2) of the laser welding system may be movable along the first axis, which allows the position of the focal point of the laser, and therefore the welding plane, to be adjusted in the Z direction. Additionally or alternatively the distance between the surface of the cell to be welded and the focus of the laser equal to a predetermined distance may be achieved by repositioning the cell. For example, the jig holding the cell(s) during welding may be controllably moveable in the Z-direction in order to permit adjustment of the distance between the surface of a cell to be welded and the focus of the laser.

Following the repositioning step, a welding step 1108 is performed as described above.

FIG. 13 shows a vehicle 1200, into which a battery module 1201, or a battery pack 1202 comprising a plurality of battery modules 1201 manufactured according to one or more of the above embodiments can be incorporated.

As discussed above, various actions may be taken based on the measured weld depth. For example, parts having a weld depth outside specification limits may be rejected and sent for reworking or, if unavoidable, scrappage. Alternatively or in addition, the weld parameters may be adjusted during the weld or before the next weld is completed.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of laser welding a tab associated with a busbar component to a terminal of an electrical cell using a laser having a focus, wherein the electrical cell is a cylindrical cell comprising a first end surface and wherein a first terminal of the electrical cell is located in a central region of the first end surface and at least part of a second terminal of the electrical cell is located in a peripheral region of the first end surface, the method comprising:
positioning the tab in contact with the peripheral region of the first end surface;
scanning the first end surface of the electrical cell to determine a position of the first end surface;
repositioning the electrical cell and/or the focus of the laser such that a distance between the first end surface and the focus of the laser is equal to a predetermined distance;
welding the tab to the second terminal of the electrical cell by controlling the laser to produce a weld on a portion of the tab that contacts the peripheral region.

2. The method as claimed in claim 1, wherein the method is a method of includes welding the busbar component to at least first and second cylindrical cells, wherein the tab is positioned in contact with the peripheral region of both of the first and second cylindrical cells and subsequently welded to the peripheral regions of each of the first and second cylindrical cells.

3. The method as claimed in claim 2, wherein the first and second cylindrical cells circumferentially abut one another.

4. The method as claimed in claim 1, wherein welding the tab comprises controlling the laser to follow a weld shape comprising oscillations about a centreline of the weld shape.

5. The method as claimed in claim 4, wherein the oscillations are circular oscillations.

6. The method as claimed in claim 4, wherein, during the welding of the tab to the electrical cell, a frequency of the oscillations is between 300 and 700 Hz.

7. The method as claimed in claim 4, wherein the oscillations have an amplitude of less than 0.5 mm.

8. A battery module comprising a plurality of cells and a busbar component, wherein: each of the plurality of cells is a cylindrical cell comprising a first end surface, wherein a first terminal of each cell is located in a central region of the first end surface and at least part of a second terminal of each cell is located in a peripheral region of the first end surface, the busbar component comprises a plurality of busbar tabs; and a plurality of the busbar tabs are each welded to the peripheral regions of one or more of the plurality of cells.

9. The battery module as claimed in claim 8, wherein the plurality of busbar tabs are each welded to the peripheral region of the first end surface of two of the plurality of cells.

10. The battery module as claimed in claim 8, wherein each of the cylindrical cells circumferentially abuts at least one other cylindrical cell.

11. A battery pack comprising a plurality of battery modules as claimed in claim 8.

12. A vehicle comprising the battery module as claimed in claim 8.

13. A vehicle comprising the battery pack as claimed in claim 11.

14. The method as claimed in claim 6, wherein, during the welding of the tab to the electrical cell, the frequency of the oscillations is between 500 and 650 Hz.
